(19) United States
(12) Patent Application Publication
(10) Pub. No.: US 2026/0342437 A1
(43) Pub. Date: Oct. 29, 2026

(54) OPTICAL-FIBER-CABLE BREAK DETECTING DEVICE, OPTICAL-FIBER-CABLE BREAK IDENTIFYING SYSTEM, AND RECORDING MEDIUM

(71) Applicant: Mitsubishi Electric Corporation, Tokyo (JP)

(72) Inventor: Norihiro TSUCHIYA, Tokyo (JP)

(73) Assignee: Mitsubishi Electric Corporation, Tokyo (JP)

(21) Appl. No.: 19/110,859

(22) PCT Filed: May 9, 2023
(86) PCT No.: PCT/JP2023/017351

§ 371 Date: Mar. 12, 2025

(51) Int. Cl. H04B 10/077

(52) U.S. Cl. CPC H04B 10/0773

(57) ABSTRACT

In an optical-fiber-cable break identifying system that includes a master device and one or more slave devices controlled by the master device, each of which is connected to another device via a transmitting optical fiber cable and a receiving optical fiber cable so as to be capable of communication with each other, the detector, in a slave device serving as a data receiver in communication via the optical fiber cables, detects any break in the receiving optical fiber cable connected to the slave device, and the transmitter transmits, through internet protocol (IP) communication to the master device, a break detection frame indicating detection of a break in the receiving optical fiber cable, when the break is detected in the receiving optical fiber cable.

### TECHNICAL FIELD

The present disclosure relates to an optical-fiber-cable break detecting device, an optical-fiber-cable break identifying system, a method for detecting a break in an optical fiber cable, and a program.

### BACKGROUND ART

Some techniques have been known for detecting an abnormality in communication cables in a system, which includes a master device and slave devices controlled by the master device connected to each other via the communication cables. For example, Patent Literature 1 discloses that, in a system including a master device, slave devices, and commercially available branch devices connected to each other via LAN cables, a slave device determines an abnormality in the LAN cables by means of reflected waves and notifies the master device of the results of determination.

### CITATION LIST

### Patent Literature

Patent Literature 1: Unexamined Japanese Patent Application Publication No. 2021-139820

### SUMMARY OF INVENTION

### Technical Problem

In contrast, in a typical existing system including a master device and slave devices connected to each other via optical fiber cables for transmission and reception, the slave device detects a link down event in the receiving optical fiber cable, and thus detects a break in the receiving optical fiber cable. The slave device then transmits a dedicated signal indicating detection of the break to another slave device connected to the receiving optical fiber cable in which the break is detected, that is, the slave device serving as the data transmitter in the communication via the optical fiber cable in which the break is detected. The slave device that has detected the break suspends data transmission to the slave device serving as the data transmitter in the communication via the optical fiber cable in which the break is detected. When the slave device serving as the data transmitter in the communication via the optical fiber cable in which the break is detected receives the dedicated signal, this slave device suspends data transmission to the slave device that has detected the break. Then, the master device detects the suspension of data transmission between the slave device that has detected the break and the slave device serving as the data transmitter in the communication via the optical fiber cable in which the break is detected. The master device thus identifies, to be a broken optical fiber cable, the optical fiber cable between the slave device that has detected the break and the slave device serving as the data transmitter in the communication via the optical fiber cable in which the break is detected.

The above-mentioned dedicated signal is, however, not recognizable by commercially available branch devices. In the case where such a commercially available branch device is disposed between the slave device that has detected the break and the slave device serving as the data transmitter in the communication via the optical fiber cable in which the break is detected, the dedicated signal cannot be successively received by the slave device serving as the data transmitter in the communication via the optical fiber cable in which the break is detected. The slave device serving as the data transmitter in the communication via the optical fiber cable in which the break is detected thus fails to suspend data transmission to the slave device that has detected the break and, as a result, there is a problem in that the broken optical fiber cable cannot be identified in the system including the commercially available branch device.

The present disclosure is made in view of the aforementioned circumstances, and an objective of the present disclosure is to provide an optical-fiber-cable break detecting device, an optical-fiber-cable break identifying system, a method for detecting a break in an optical fiber cable, and a program that can achieve identification of a broken optical fiber cable, regardless of a commercially available branch device included in the system.

### Solution to Problem

In order to achieve the above objective, an optical-fiber-cable break detecting device according to the present disclosure is included in an optical-fiber-cable break identifying system including a master device and one or more slave devices controlled by the master device, each of which is connected to another device via a transmitting optical fiber cable and a receiving optical fiber cable so as to be capable of communication with each other. The optical-fiber-cable break detecting device includes: detection means, in one of the slave devices serving as a data receiver in communication via the optical fiber cables, for detecting any break in the receiving optical fiber cable connected to the slave device; and transmission means for transmitting, to the master device through internet protocol (IP) communication, a break detection frame indicating detection of a break in the receiving optical fiber cable, when the detection means detects the break in the receiving optical fiber cable.

### Advantageous Effects of Invention

The present disclosure can provide an optical-fiber-cable break detecting device, an optical-fiber-cable break identifying system, a method for detecting a break in an optical fiber cable, and a program that can achieve identification of a broken optical fiber cable, regardless of a commercially available branch device included in the system.

### BRIEF DESCRIPTION OF DRAWINGS

FIG. 1 illustrates an exemplary configuration of an optical-fiber-cable break identifying system according to an embodiment;

FIG. 2 illustrates a hardware configuration of an information processing device according to the embodiment;

FIG. 3 illustrates a functional configuration of the optical-fiber-cable break identifying system according to the embodiment;

FIG. 4 is a flowchart illustrating a process of a slave device included in the optical-fiber-cable break identifying system according to the embodiment; and

FIG. 5 is a flowchart illustrating a process of a master device included in the optical-fiber-cable break identifying system according to the embodiment.

### DESCRIPTION OF EMBODIMENTS

### Embodiment

An optical-fiber-cable break identifying system 1 according to an embodiment is designed to identify a break in optical fiber cables that mutually connect the devices included in the system.

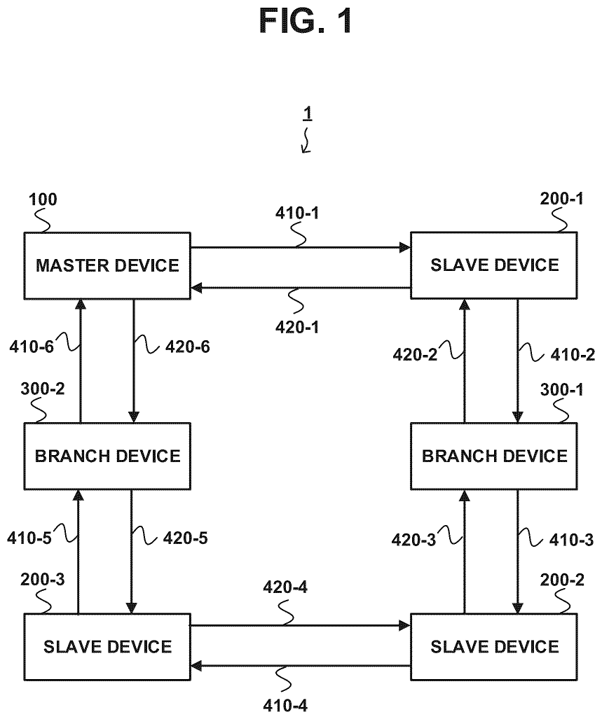

As illustrated in FIG. 1, the optical-fiber-cable break identifying system 1 includes a master device 100, one or more slave devices 200-1, . . . , and 200-i (i: natural number equal to or larger than 1), and one or more branch devices 300-1, . . . , and 300-j (j: natural number equal to or larger than 1). In the following description, the slave devices 200-1, . . . , and 200-i are collectively referred to as “slave devices 200” except for the case of referring to a specific one of the slave devices. The branch devices 300-1, . . . , and 300-j are collectively referred to as “branch devices 300” except for the case of referring to a specific one of the branch devices. FIG. 1 illustrates an example of the optical-fiber-cable break identifying system including a master device 100, three slave devices 200, and two branch devices 300 connected in a ring shape.

The master device 100 controls the slave devices 200. A typical example of the master device 100 is a programmable logic controller (PLC) for controlling factory automation (FA) devices.

The slave devices 200 are controlled by the master device 100. A typical example of the slave devices 200 is an FA device. Each of the slave devices 200 has functions of an optical-fiber-cable break detecting device 500, as described below. The optical-fiber-cable break detecting device 500 performs a function of detecting a break in an optical fiber cable connected to the slave device 200.

The branch devices 300 each relay communication between the slave devices 200 or communication between each slave device 200 and the master device 100. A typical example of the branch device 300 is a hub.

In the optical-fiber-cable break identifying system 1, each of the master device 100 and the one or more slave devices 200 controlled by the master device is connected to another device so as to be capable of communication with each other, via a transmitting optical fiber cable and a receiving optical fiber cable.

For example, as illustrated in FIG. 1, the master device 100 is connected to an optical fiber cable 410-1 serving as the transmitting optical fiber cable in the communication with the slave device 200-1, and connected to an optical fiber cable 420-1 serving as the receiving optical fiber cable in the communication with the slave device 200-1. The master device 100 is also connected to an optical fiber cable 420-6 serving as the transmitting optical fiber cable in the communication with the slave device 200-3, and connected to an optical fiber cable 410-6 serving as the receiving optical fiber cable in the communication with the slave device 200-3. The master device 100 is regarded to be connected to an optical fiber cable 420-5 serving as the transmitting optical fiber cable in the communication with the slave device 200-3, and regarded to be connected to an optical fiber cable 410-5 serving as the receiving optical fiber cable in the communication with the slave device 200-3.

The slave device 200-1 is connected to the optical fiber cable 420-1 serving as the transmitting optical fiber cable in the communication with the master device 100, and connected to the optical fiber cable 410-1 serving as the receiving optical fiber cable in the communication with the master device 100. The slave device 200-1 is also connected to an optical fiber cable 410-2 serving as the transmitting optical fiber cable in the communication with the slave device 200-2, and connected to an optical fiber cable 420-2 serving as the receiving optical fiber cable in the communication with the slave device 200-2. The slave device 200-1 is regarded to be connected to an optical fiber cable 410-3 serving as the transmitting optical fiber cable in the communication with the slave device 200-2, and regarded to be connected to an optical fiber cable 420-3 serving as the receiving optical fiber cable in the communication with the slave device 200-2.

The slave device 200-2 is connected to the optical fiber cable 420-3 serving as the transmitting optical fiber cable in the communication with the slave device 200-1, and connected to the optical fiber cable 410-3 serving as the receiving optical fiber cable in the communication with the slave device 200-1. The slave device 200-2 is regarded to be connected to the optical fiber cable 420-2 serving as the transmitting optical fiber cable in the communication with the slave device 200-1, and regarded to be connected to the optical fiber cable 410-2 serving as the receiving optical fiber cable in the communication with the slave device 200-1. The slave device 200-2 is also connected to an optical fiber cable 410-4 serving as the transmitting optical fiber cable in the communication with the slave device 200-3, and connected to an optical fiber cable 420-4 serving as the receiving optical fiber cable in the communication with the slave device 200-3.

The slave device 200-3 is connected to the optical fiber cable 420-4 serving as the transmitting optical fiber cable in the communication with the slave device 200-2, and connected to the optical fiber cable 410-4 serving as the receiving optical fiber cable in the communication with the slave device 200-2. The slave device 200-3 is also connected to the optical fiber cable 410-5 serving as the transmitting optical fiber cable in the communication with the master device 100, and connected to the optical fiber cable 420-5 serving as the receiving optical fiber cable in the communication with the master device 100. The slave device 200-3 is regarded to be connected to the optical fiber cable 410-6 serving as the transmitting optical fiber cable in the communication with the master device 100, and regarded to be connected to the optical fiber cable 420-6 serving as the receiving optical fiber cable in the communication with the master device 100.

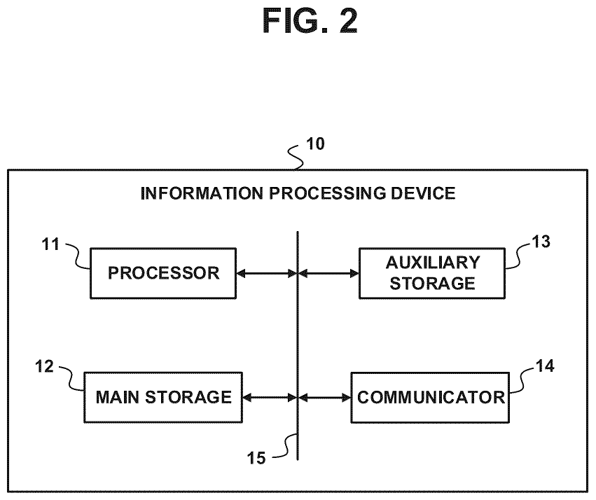

FIG. 2 illustrates an exemplary hardware configuration of an information processing device 10 that performs functions of each of the master device 100 and the slave devices 200.

The information processing device 10 includes a processor 11 that executes various processes, a main storage 12 that serves as a work area of the processor 11, an auxiliary storage 13 that stores various types of data to be used in the processes of the processor 11, and a communicator 14 for communication with external devices. The main storage 12, the auxiliary storage 13, and the communicator 14 are each connected to the processor 11 via buses 15.

The processor 11 includes a central processing unit (CPU) that executes various processes. The processor 11 executes a program stored in the auxiliary storage 13 and thereby performs various functions of the information processing device 10.

The main storage 12 includes a random access memory (RAM). The main storage 12 receives a program loaded from the auxiliary storage 13. The main storage 12 serves as a work area of the processor 11.

The auxiliary storage 13 includes a non-volatile memory, such as electrically erasable programmable read-only memory (EEPROM). The auxiliary storage 13 stores the program and various types of data used in processes of the processor 11. The auxiliary storage 13 provides the processor 11 with data to be used by the processor 11 and stores data fed from the processor 11 under the instructions from the processor 11.

The communicator 14 includes a network interface circuit for communication with external devices. The communicator 14 receives signals from external devices and outputs data indicated by the signals to the processor 11. The communicator 14 also transmits signals indicating the data output from the processor 11 to external devices.

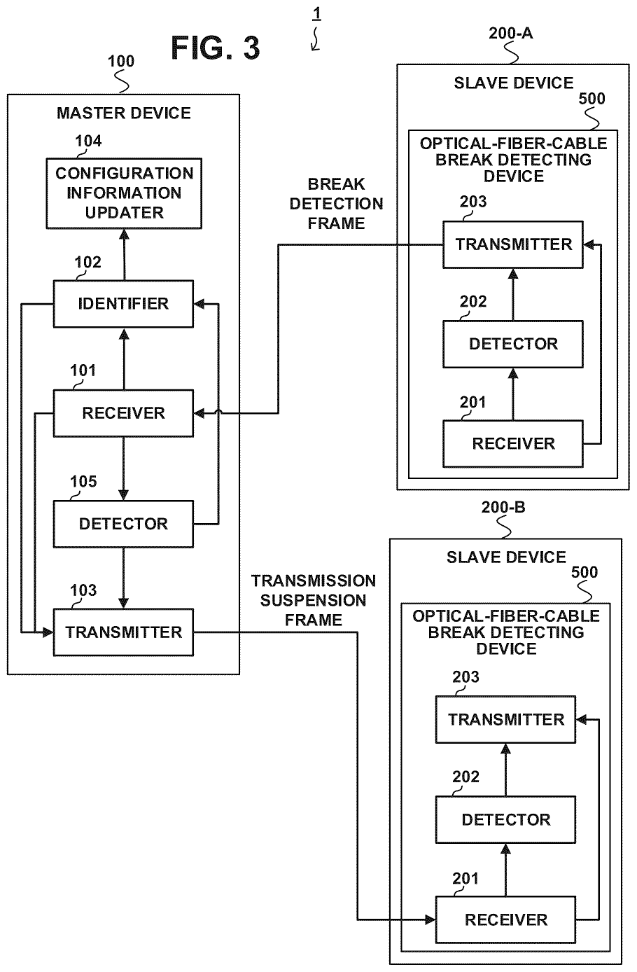

The following describes functions of the optical-fiber-cable break identifying system 1, with reference to FIG. 3. The optical-fiber-cable break identifying system 1 includes the slave devices 200, each of which includes the optical-fiber-cable break detecting device 500. In the following description, the slave device 200 serving as the data receiver in the communication via a broken optical fiber cable is referred to as “slave device 200-A”, and the slave device 200 serving as the data transmitter in the communication via the broken optical fiber cable is referred to as “slave device 200-B”.

In an exemplary case where the optical fiber cable 410-2 or 410-3 is broken in the optical-fiber-cable break identifying system 1 illustrated in FIG. 1, the slave device 200-A serving as the data receiver in the communication via the broken optical fiber cable corresponds to the slave device 200-2, and the slave device 200-B serving as the data transmitter in the communication via the broken optical fiber cable corresponds to the slave device 200-1.

The following first describes functions of the optical-fiber-cable break detecting device 500. The optical-fiber-cable break detecting device 500 has functional components including a receiver 201 that receives data from another device included in the optical-fiber-cable break identifying system 1, a detector 202 that detects a break, and a transmitter 203 that transmits data to another device included in the optical-fiber-cable break identifying system 1.

The receiver 201 receives data from another device included in the optical-fiber-cable break identifying system 1 via a receiving optical fiber cable. The receiver 201 is achieved by the processor 11 and the communicator 14.

Specifically, the receiver 201 receives data from any of the master device 100 and the other slave devices 200. In the exemplary system configuration illustrated in FIG. 1, the receiver 201 of the slave device 200-2 receives data from the slave device 200-1 via the optical fiber cables 410-2 and 410-3. The receiver 201 of the slave device 200-2 also receives data from the slave device 200-3 via the optical fiber cable 420-4.

The receiver 201, when receiving an optical signal, detects a link up event and a link down event in the receiving optical fiber cable.

For example, the receiver 201 of the slave device 200-2 detects a link up event and a link down event in the optical fiber cable 410-3 or 420-4. In an exemplary case of a break in the optical fiber cable 410-2 or 410-3 illustrated in FIG. 1, the receiver 201 of the slave device 200-2 (slave device 200-A) detects a link down event in the optical fiber cable 410-3.

The detector 202, in the slave device 200 serving as the data receiver in the communication via the optical fiber cable, detects any break in the receiving optical fiber cable connected to this slave device 200. The detector 202 is achieved by the processor 11. The detector 202 is an example of detection means.

Specifically, the detector 202 monitors the detection status in the receiving optical fiber cable by the receiver 201, and detects a break in the receiving optical fiber cable when the receiver 201 detects a link down event in the receiving optical fiber cable. For example, when the receiver 201 of the slave device 200-2 (slave device 200-A) serving as the data receiver in the communication via the optical fiber cables 410-2 and 410-3 detects a link down event in the optical fiber cable 410-3, the detector 202 detects that a break exists in the optical fiber cable 410-2 or 410-3 connected to the slave device 200-2 (slave device 200-A).

The transmitter 203 transmits data to another device included in the optical-fiber-cable break identifying system 1 via a transmitting optical fiber cable. The transmitter 203 is achieved by the processor 11 and the communicator 14. The transmitter 203 is an example of transmission means and first transmission means.

Specifically, the transmitter 203 transmits data to any of the master device 100 and the other slave devices 200. For example, the transmitter 203 of the slave device 200-2 transmits data to the slave device 200-1 via the optical fiber cables 420-2 and 420-3. The transmitter 203 of the slave device 200-2 transmits data to the slave device 200-3 via the optical fiber cable 410-4.

The transmitter 203 transmits, to the master device 100 through the IP communication, a break detection frame indicating detection of a break in the receiving optical fiber cable when the detector 202 detects the break in the receiving optical fiber cable.

The break detection frame, which is transmitted from the slave device 200, indicates that a break is detected in the receiving optical fiber cable connected to the slave device 200.

The break detection frame contains information for identifying the receiving optical fiber cable connected to the slave device 200 that transmits this frame. A typical example of this information indicates the number of the communication port connected to the optical fiber cable. For example, since the slave device 200-2 is connected to the optical fiber cables 410-3 and 420-4 serving as receiving optical fiber cables, the break detection frame transmitted from the transmitter 203 of the slave device 200-2 (slave device 200-A) contains the information on the number of the communication port connected to the optical fiber cable 410-3 or 420-4 in which a break is detected.

For example, when the detector 202 of the slave device 200-2 (slave device 200-A) detects a break in the optical fiber cable 410-2 or 410-3, the transmitter 203 transmits a break detection frame containing the information on the number of the communication port connected to the optical fiber cable 410-3, to the master device 100 through the IP communication.

Alternatively, the break detection frame may contain identification information for identifying the slave device serving as the data transmitter in the communication via the receiving optical fiber cable in which the break is detected. Examples of the identification information include the media access control (MAC) addresses or the internet protocol (IP) addresses assigned to the slave devices 200.

For example, the identification information on the devices included in the optical-fiber-cable break identifying system 1 is acquired in the optical-fiber-cable break identifying system 1, in accordance with a known protocol, such as link layer discovery protocol (LLDP), or a protocol uniquely developed by the administrator or user of the optical-fiber-cable break identifying system 1. The identification information may be acquired before or after the detection of a break by the slave device 200.

For example, when the detector 202 of the slave device 200-2 (slave device 200-A) detects the break in the optical fiber cable 410-2 or 410-3, the transmitter 203 transmits a break detection frame containing the MAC address and the IP address of the slave device 200-1 serving as the data transmitter in the communication via the optical fiber cables 410-2 and 410-3, to the master device 100 through the IP communication.

Also, the transmitter 203 suspends data transmission to the slave device 200 serving as the data transmitter in the communication via the receiving optical fiber cable in which the break is detected.

For example, the transmitter 203 of the slave device 200-2 (slave device 200-A) suspends data transmission, via the optical fiber cables 420-2 and 420-3, to the slave device 200-1 (slave device 200-B) serving as the data transmitter in the communication via the optical fiber cables 410-2 and 410-3.

The following describes functions of the master device 100 illustrated in FIG. 3. The master device 100 has functional components including a receiver 101 that receives data from each slave device 200, an identifier 102 that identifies the slave device 200 serving as the data transmitter in the communication via the broken receiving optical fiber cable, a transmitter 103 that transmits data to each slave device 200, a configuration information updater 104 that updates configuration information, and a detector 105 that detects a break.

The receiver 101 receives data from each slave device 200 included in the optical-fiber-cable break identifying system 1, via the receiving optical fiber cable. The receiver 101 is achieved by the processor 11 and the communicator 14. The receiver 101 is an example of reception means.

For example, the receiver 101 of the master device 100 receives data from the slave device 200-1 via the optical fiber cable 420-1. The receiver 101 of the master device 100 also receives data from the slave device 200-3 via the optical fiber cables 410-5 and 410-6.

The receiver 101 receives the break detection frame from the slave device 200.

For example, the receiver 101 of the master device 100 receives, from the slave device 200-2 (slave device 200-A), the break detection frame containing the information on the number of the communication port connected to the optical fiber cable 410-3.

Alternatively, the receiver 101 of the master device 100 receives, from the slave device 200-2 (slave device 200-A), the break detection frame containing the MAC address and the IP address of the slave device 200-1 serving as the data transmitter in the communication via the optical fiber cables 410-2 and 410-3.

The identifier 102 identifies the slave device 200 serving as the data transmitter in the communication via the receiving optical fiber cable in which the break is detected as indicated by the break detection frame received by the receiver 101. The identifier 102 is achieved by the processor 11. The identifier 102 is an example of identification means.

For example, the identifier 102 identifies the slave device 200 serving as the data transmitter in the communication via the receiving optical fiber cable in which the break is detected, on the basis of the configuration information stored in the master device 100.

The configuration information contains identification information for identifying the devices included in the optical-fiber-cable break identifying system 1, and information indicating the connection relationship between the devices. A typical example of the configuration information contains the MAC addresses and the IP addresses of the individual devices, and information on which communication port of each device is used in communication with another device.

For example, the receiver 101 of the master device 100 receives, from the slave device 200-2 (slave device 200-A), the break detection frame containing the number of the communication port connected to the optical fiber cable 410-3. In this case, the identifier 102 of the master device 100 refers to the MAC address and the IP address of the slave device 200-2 (slave device 200-A), the number of the communication port, and the configuration information, and thus identifies the slave device 200-1 (slave device 200-B) to be the slave device 200 serving as the data transmitter in the communication via the optical fiber cable 410-2 or 410-3 in which the break is detected.

In another example, the receiver 101 of the master device 100 receives, from the slave device 200-2 (slave device 200-A), the break detection frame containing the MAC address and the IP address of the slave device 200-1 (slave device 200-B). In this case, the identifier 102 identifies the slave device 200-1 (slave device 200-B) to be the slave device 200 serving as the data transmitter in the communication via the broken optical fiber cable, on the basis of the MAC address and the IP address contained in the received break detection frame. This case can skip the step of referring to the configuration information to identify the slave device serving as the data transmitter in the communication via the broken optical fiber cable.

The transmitter 103 transmits data to each slave device 200 included in the optical-fiber-cable break identifying system 1, via the transmitting optical fiber cable. The transmitter 103 is achieved by the processor 11 and the communicator 14. The transmitter 103 is an example of second transmission means.

For example, the transmitter 103 of the master device 100 transmits data to the slave device 200-1 via the optical fiber cable 410-1. The transmitter 103 of the master device 100 also transmits data to the slave device 200-3 via the optical fiber cables 420-5 and 420-6.

The transmitter 103 transmits, to the slave device 200 serving as the data transmitter as identified by the identifier 102, a transmission suspension frame for instructing the slave device serving as the data transmitter to suspend data transmission to the slave device 200 serving as the data receiver in the communication via the receiving optical fiber cable in which the break is detected as indicated by the break detection frame.

The transmission suspension frame, which is transmitted from the master device 100 to the slave device 200-B, contains an instruction for causing the slave device 200 serving as the data transmitter in the communication via the optical fiber cable in which the break is detected to suspend data transmission to the slave device 200 serving as the data receiver. A typical example of the transmission suspension frame contains identification information on the slave device 200 serving as the data receiver.

For example, the transmitter 103 of the master device 100 transmits a transmission suspension frame containing the MAC address and the IP address of the slave device 200-2 (slave device 200-A), to the slave device 200-1 (slave device 200-B).

The slave device 200 serving as the data transmitter, when receiving the transmission suspension frame, suspends data transmission to the slave device 200 serving as the data receiver in the communication via the optical fiber cable in which the break is detected.

For example, when the receiver 201 of the slave device 200-1 (slave device 200-B) receives the transmission suspension frame containing the identification information on the slave device 200-2 (slave device 200-A) from the master device 100, the transmitter 203 of the slave device 200-1 (slave device 200-B) suspends data transmission to the slave device 200-2 (slave device 200-A) serving as the data receiver in the communication via the optical fiber cables 410-2 and 410-3.

Also, the transmitter 103 suspends transmission of a cyclic frame to the slave device 200 serving as the data transmitter as identified by the identifier 102. The cyclic frame is transmitted for regular data exchange among the devices in the same network.

For example, the transmitter 103 suspends transmission of a cyclic frame to the slave device 200-1 (slave device 200-B).

The configuration information updater 104 updates the configuration information, when the identifier 102 identifies the slave device 200 serving as the data transmitter in the communication via the receiving optical fiber cable in which the break is detected. The configuration information updater 104 is achieved by the processor 11.

For example, when the identifier 102 identifies the slave device 200-1 (slave device 200-B) to be the slave device 200 serving as the data transmitter in the communication via the receiving optical fiber cable in which the break is detected, the configuration information updater 104 determines that the slave device 200-1 (slave device 200-B) is disconnected, and updates the information that is contained in the configuration information and indicates the connection relationship to information indicating disconnection of the slave device 200-1 (slave device 200-B).

The detector 105 detects any break in the receiving optical fiber cable. The detector 105 is achieved by the processor 11.

Specifically, the detector 105 monitors the detection status in the receiving optical fiber cable by the receiver 101, and detects a break in the receiving optical fiber cable when the receiver 101 detects a link down event in the receiving optical fiber cable. For example, when the receiver 101 of the master device 100 detects a link down event in the optical fiber cable 410-6, the detector 105 detects a break in the optical fiber cable 410-5 or 410-6.

When the detector 105 detects the break in the optical fiber cable, the identifier 102 refers to the configuration information and the number of the communication port connected to the optical fiber cable in which the break is detected, and identifies the slave device 200 serving as the data transmitter in the communication via the optical fiber cable in which the break is detected. The transmitter 103 then transmits a transmission suspension frame to the slave device 200 identified by the identifier 102. The configuration information updater 104 then updates the configuration information.

For example, when the detector 105 detects the break in the optical fiber cable 410-5 or 410-6, the identifier 102 identifies the slave device 200-3 (slave device 200-B) to be the slave device 200 serving as the data transmitter in the communication via the optical fiber cables 410-5 and 410-6. The transmitter 103 then transmits a transmission suspension frame to the slave device 200-3, and suspends transmission of a cyclic frame to the slave device 200-3. The configuration information updater 104 then determines that the slave device 200-3 (slave device 200-B) is disconnected, and updates the information that is contained in the configuration information and indicates the connection relationship to information indicating disconnection of the slave device 200-3 (slave device 200-B).

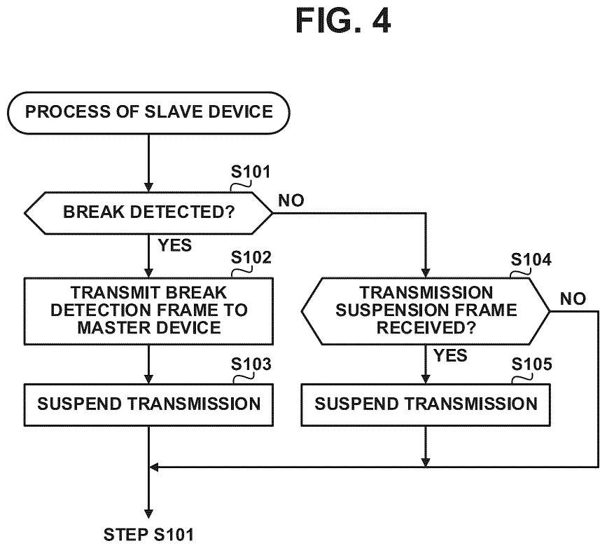

The following describes a process executed by each of the slave devices 200 according to the embodiment, with reference to the flowchart of FIG. 4. The process illustrated in FIG. 4 is executed in response to activation of the slave device 200, for example.

The detector 202, in the slave device 200 serving as the data receiver in the communication via the optical fiber cable, determines whether any break is detected in the receiving optical fiber cable connected to this slave device 200 (Step S101). When the detector 202 determines that the break is detected in the receiving optical fiber cable (Step S101; YES), the transmitter 203 transmits, to the master device 100 through the IP communication, a break detection frame indicating detection of a break in the receiving optical fiber cable (Step S102). The transmitter 203 then suspends data transmission to the slave device 200 serving as the data transmitter in the communication via the receiving optical fiber cable in which the break is detected (Step S103). The process then returns to Step S101. In contrast, when the detector 202 determines that no break is detected in the receiving optical fiber cable (Step S101; NO), the receiver 201 determines whether a transmission suspension frame is received from the master device 100 (Step S104).

For example, when the receiver 201 of the slave device 200-2 (slave device 200-A) serving as the data receiver in the communication via the optical fiber cables 410-2 and 410-3 detects a link down event in the optical fiber cable 410-3, the detector 202 of the slave device 200-2 (slave device 200-A) detects that a break exists in the optical fiber cable 410-2 or 410-3 connected to the slave device 200-2 (slave device 200-A). The transmitter 203 of the slave device 200-2 (slave device 200-A) then transmits a break detection frame containing the MAC address and the IP address of the slave device 200-1 serving as the data transmitter in the communication via the optical fiber cables 410-2 and 410-3, to the master device 100 through the IP communication. The transmitter 203 of the slave device 200-2 (slave device 200-A) then suspends data transmission to the slave device 200-1 (slave device 200-B) via the optical fiber cables 420-2 and 420-3. In contrast, when the receiver 201 of the slave device 200-1 serving as the data receiver in the communication via the optical fiber cables 420-2 and 420-3 detects no break in the optical fiber cables 420-2 and 420-3, the receiver 201 determines whether a transmission suspension frame is received from the master device 100.

In Step S104, when the receiver 201 determines that the transmission suspension frame is received from the master device 100 (Step S104; YES), the transmitter 203 suspends data transmission to the slave device serving as the data receiver in the communication via the receiving optical fiber cable in which the break is detected as indicated by the break detection frame (Step S105). In contrast, when the receiver 201 determines that no transmission suspension frame is received from the master device 100 (Step S104; NO), the process returns to Step S101.

For example, when the receiver 201 of the slave device 200-1 (slave device 200-B) receives a transmission suspension frame containing the identification information on the slave device 200-2 (slave device 200-A) from the master device 100, the transmitter 203 of the slave device 200-1 (slave device 200-B) suspends data transmission to the slave device 200-2 (slave device 200-A). In contrast, when the receiver 201 of the slave device 200-1 (slave device 200-B) receives no transmission suspension frame from the master device 100, the process returns to Step S101.

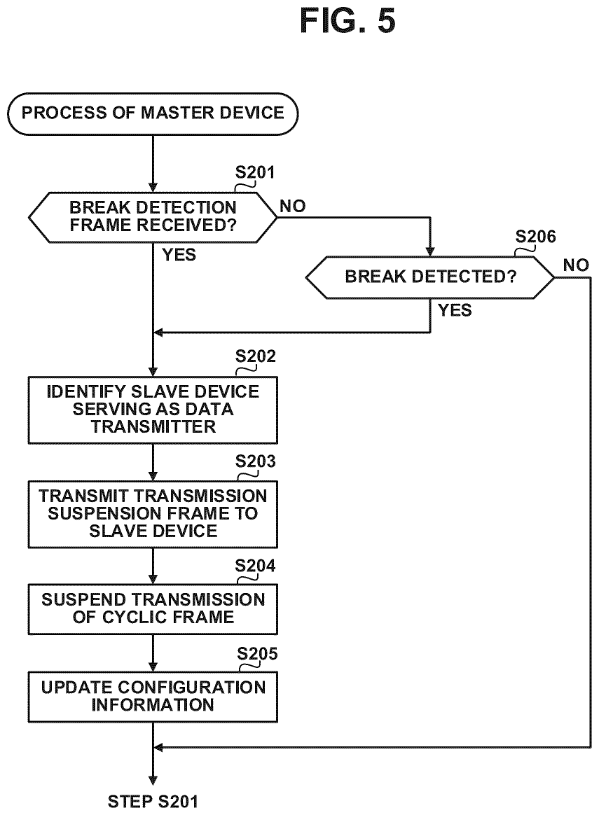

The following describes a process executed by the master device 100 according to the embodiment, with reference to the flowchart of FIG. 5. The process illustrated in FIG. 5 is executed in response to activation of the master device 100, for example.

The receiver 101 determines whether a break detection frame is received from any slave device 200 (Step S201). When the receiver 101 determines that the break detection frame is received from any slave device 200 (Step S201; YES), the identifier 102 identifies the slave device 200 serving as the data transmitter in the communication via the receiving optical fiber cable in which the break is detected as indicated by the break detection frame received by the receiver 101 (Step S202). In contrast, when the receiver 101 determines that no break detection frame is received from the slave devices 200 (Step S201; NO), the detector 105 determines whether any break is detected in the optical fiber cables (Step S206).

For example, when the receiver 101 of the master device 100 receives, from the slave device 200-2 (slave device 200-A), a break detection frame containing the MAC address and the IP address of the slave device 200-1 (slave device 200-B) serving as the data transmitter in the communication via the optical fiber cables 410-2 and 410-3, the identifier 102 identifies the slave device 200-1 (slave device 200-B) to be the slave device 200 serving as the data transmitter in the communication via the broken optical fiber cable, on the basis of the MAC address and the IP address contained in the break detection frame. In contrast, when the receiver 101 determines that no break detection frame is received from the slave device 200, the detector 105 determines whether any break is detected in the optical fiber cables 420-1, 410-5, and 410-6.

The transmitter 103 transmits, to the slave device 200 serving as the data transmitter as identified by the identifier 102, a transmission suspension frame for instructing the slave device 200 to suspend data transmission to the slave device 200 serving as the data receiver in the communication via the receiving optical fiber cable in which the break is detected as indicated by the break detection frame (Step S203). Also, the transmitter 103 suspends transmission of a cyclic frame to the slave device 200 serving as the data transmitter as identified by the identifier 102 (Step S204). The configuration information updater 104 then updates the configuration information (Step S205). The process then returns to Step S201.

For example, the transmitter 103 of the master device 100 transmits, to the slave device 200-1 (slave device 200-B), a transmission suspension frame containing the MAC address and the IP address of the slave device 200-2 (slave device 200-A). Also, the transmitter 103 suspends transmission of a cyclic frame to the slave device 200-1 (slave device 200-B). The configuration information updater 104 then determines that the slave device 200-1 (slave device 200-B) is disconnected, and updates the connection information contained in the configuration information on the basis of information indicating disconnection of the slave device 200-1 (slave device 200-B).

In Step S206, when the detector 105 detects the break in the optical fiber cable (Step S206; YES), the process goes to Step S202 and the following steps. In contrast, when the detector 105 detects no break in the optical fiber cable (Step S206; NO), the process returns to Step S201.

For example, when the detector 105 detects the break in the optical fiber cable 410-5 or 410-6, the identifier 102 identifies the slave device 200-3 (slave device 200-B) to be the slave device 200 serving as the data transmitter in the communication via the optical fiber cables 410-5 and 410-6. The transmitter 103 then transmits a transmission suspension frame to the slave device 200-3, and suspends transmission of a cyclic frame to the slave device 200-3. The configuration information updater 104 then updates the information that is contained in the configuration information and indicates the connection relationship to information indicating disconnection of the slave device 200-3 (slave device 200-B).

In response to a break in an optical fiber cable in the system according to the embodiment, the slave device that has detected the break notifies the master device of the break, using the widely-used general internet protocol. The system can thus achieve detection and identification of the break in the optical fiber cables regardless of a commercially available branch device included in the system.

In some existing techniques, the master device analyzes the cyclic frames transmitted and received within the system, detects the suspension of the transmission and reception between the devices, and thus identifies the broken optical fiber cable. In contrast, in the technique according to the embodiment, the master device is able to identify the broken optical fiber cable without analyzing cyclic frames, because the master device receives a break detection frame containing information by which the broken optical fiber cable can be identified, from the slave device that has detected the broken optical fiber cable. The technique according to the embodiment can skip the analyzing process of the master device and thus reduce the processing load on the master device.

Some existing procedures have been known for detecting whether a cable is broken by means of reflected waves. These procedures require dedicated mechanisms for detection of a break, such as pulse transmitter and signal diagnoser, in addition to the mechanisms for data exchange for control. In contrast, the technique according to the embodiment does not require a dedicated mechanism for detection of a break, because the detection is based on detection of a link down event. This technique can therefore identify a break in the optical fiber cables with a simple structure.

In the embodiment, the break detection frame can contain identification information for identifying the slave device serving as the data transmitter in the communication via the broken optical fiber cable. The master device is thus able to identify the slave device serving as the data transmitter in the communication via the broken optical fiber cable, without identifying the slave device serving as the data transmitter in the communication via the broken optical fiber cable on the basis of the configuration information. The master device therefore has a reduced processing load.

### Modifications

The above-described embodiment of the present disclosure may be varied and revised into various modifications.

Although the transmitter 203 transmits a break detection frame to the master device 100 in the above-described embodiment, this configuration is a mere example. The transmitter 203 may further transmit the break detection frame to a slave device serving as the data transmitter in the communication via the receiving optical fiber cable in which the break is detected, through the IP communication. The slave device serving as the data transmitter, when receiving the break detection frame, suspends data transmission to the slave device serving as the data receiver in the communication via the receiving optical fiber cable in which the break is detected as indicated by the break detection frame.

For example, when the detector 202 of the slave device 200-2 (slave device 200-A) detects the break in the optical fiber cable 410-2 or 410-3, the transmitter 203 transmits a break detection frame to not only the master device 100 but also the slave device 200-1 (slave device 200-B), through the IP communication.

When the receiver 201 of the slave device 200-1 (slave device 200-B) receives the break detection frame from the slave device 200-2 (slave device 200-A), the transmitter 203 of the slave device 200-1 (slave device 200-B) suspends data transmission to the slave device 200-2 (slave device 200-A) serving as the data receiver in the communication via the optical fiber cables 410-2 and 410-3.

That is, the slave device serving as the data transmitter in the communication via the optical fiber cable in which the break is detected receives the break detection frame, and then suspends data transmission to the slave device serving as the data receiver. The slave device serving as the data transmitter can thus suspend data transmission at an earlier timing than the slave device that suspends data transmission after receiving the transmission suspension frame from the master device 100. This modification can achieve fail-safe operations in the system, and reduce the downtime of the system and the time until actions in the case of abnormality, for example.

Although FIG. 5 illustrates the process executed by the master device in the above-described embodiment, the timing of each step of the process is a mere example. For example, the order of Steps S203 to S205 may be shuffled.

An operational program that defines the operations of the optical-fiber-cable break detecting device according to the above-described embodiment may be applied to an existing personal computer or information terminal device, and thus cause the personal computer or information terminal device to function as the optical-fiber-cable break detecting device according to the embodiment.

Such a program may be distributed by any procedure. For example, the program may be stored in a non-transitory computer-readable recording medium, such as compact disk read-only memory (CD-ROM), digital versatile disk (DVD), or memory card, and distributed. The program may also be distributed via a communication network, such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure can provide an optical-fiber-cable break detecting device, an optical-fiber-cable break identifying system, a method for detecting a break in an optical fiber cable, and a program that can achieve identification of a broken optical fiber cable, regardless of a commercially available branch device included in the system.

### REFERENCE SIGNS LIST

1 Optical-fiber-cable break identifying system
10 Information processing device
11 Processor
12 Main storage
13 Auxiliary storage
14 Communicator
15 Bus
100 Master device
101, 201 Receiver
102 Identifier
103, 203 Transmitter
104 Configuration information updater
105, 202 Detector
200, 200-1, 200-2, 200-3, 200-i, 200-A, 200-B Slave device
300, 300-1, 300-2, 300-j Branch device
410-1, 410-2, 410-3, 410-4, 410-5, 410-6, 420-1, 420-2, 420-3, 420-4, 420-5, 420-6 Optical fiber cable
500 Optical-fiber-cable break detecting device

1. An optical-fiber-cable break detecting device comprising:
processing circuitry; and
a storage, wherein
in an optical-fiber-cable break identifying system including a master device and one or more slave devices controlled by the master device, each of the master device and the one or more slave devices being connected to another device via a transmitting optical fiber cable and a receiving optical fiber cable so as to be capable of communication with each other, the optical-fiber-cable break identifying system further including one or more branch devices to relay communication between the one or more slave devices or communication between each of the one or more slave devices and the master device, the processing circuitry:
detects, in one of the slave devices serving as a data receiver in communication via the optical fiber cables, any break in the receiving optical fiber cable connected to the slave device, and
transmits, to the master device through internet protocol (IP) communication, a break detection frame indicating detection of a break in the receiving optical fiber cable, when the break is detected in the receiving optical fiber cable.

2. The optical-fiber-cable break detecting device according to claim 1, wherein the processing circuitry transmits the break detection frame containing identification information for identifying one of the slave devices serving as a data transmitter in communication via the receiving optical fiber cable in which the break is detected.

3. The optical-fiber-cable break detecting device according to claim 1, wherein
the processing circuitry further transmits, through the IP communication, the break detection frame to one of the slave devices serving as a data transmitter in communication via the receiving optical fiber cable in which the break is detected, and
the slave device serving as the data transmitter, when receiving the break detection frame, suspends data transmission to the slave device serving as the data receiver in the communication via the receiving optical fiber cable in which the break is detected as indicated by the break detection frame.

4. An optical-fiber-cable break identifying system including a master device and one or more slave devices controlled by the master device, each of the master device and the one or more slave devices being connected to another device via a transmitting optical fiber cable and a receiving optical fiber cable so as to be capable of communication with each other, the optical-fiber-cable break identifying system further including one or more branch devices to relay communication between the one or more slave devices or communication between each of the one or more slave devices and the master device, wherein
the one or more slave devices each include first processing circuitry and a first storage,
the master device includes second processing circuitry and a second storage,
the first processing circuitry
detects, in one of the slave devices serving as a data receiver in communication via the optical fiber cables, any break in the receiving optical fiber cable connected to the slave device, and
transmits, to the master device through IP communication, a break detection frame indicating detection of a break in the receiving optical fiber cable, when the break is detected in the receiving optical fiber cable, and
the second processing circuitry
receives the break detection frame,
identifies one of the slave devices serving as a data transmitter in communication via the receiving optical fiber cable in which the break is detected as indicated by the received break detection frame, and
transmits, to the identified slave device serving as the data transmitter, a transmission suspension frame for instructing the slave device serving as the data transmitter to suspend data transmission to the slave device serving as the data receiver in the communication via the receiving optical fiber cable in which the break is detected as indicated by the break detection frame.

5. (canceled)

6. A non-transitory computer-readable recording medium storing a program, in an optical-fiber-cable break identifying system including a master device and one or more slave devices, each of the master device and the one or more slave devices being connected to another device via a transmitting optical fiber cable and a receiving optical fiber cable so as to be capable of communication with each other, the optical-fiber-cable break identifying system further including one or more branch devices to relay communication between the one or more slave devices or communication between each of the one or more slave devices and the master device, the program being configured to cause a computer to perform operations comprising:
detecting, in one of the slave devices serving as a data receiver in communication via the optical fiber cables, any break in the receiving optical fiber cable connected to the slave device; and
transmitting, to the master device through IP communication, a break detection frame indicating detection of a break in the receiving optical fiber cable, when the break is detected in the receiving optical fiber cable.

7. The optical-fiber-cable break detecting device according to claim 2, wherein
the processing circuitry further transmits, through the IP communication, the break detection frame to one of the slave devices serving as a data transmitter in communication via the receiving optical fiber cable in which the break is detected, and
the slave device serving as the data transmitter, when receiving the break detection frame, suspends data transmission to the slave device serving as the data receiver in the communication via the receiving optical fiber cable in which the break is detected as indicated by the break detection frame.
